(19) United States
(12) Patent Application Publication
(10) Pub. No.: US 2025/0011182 A1
(43) Pub. Date: Jan. 9, 2025

(54) DEVICE AND METHOD FOR RECOVERING LITHIUM FROM LITHIUM-CONTAINING MOTHER LIQUOR IN THE PROCESS OF PREPARING LITHIUM CARBONATE

(71) Applicant: XI’AN LANSHEN NEW MATERIAL TECHNOLOGY CO., LTD., Xi’an (CN)

(72) Inventors: Zhijun FENG, Xi’an (CN); Xiaolong TAN, Xi’an (CN); Ang MEI, Xi’an (CN); Bingjie SUN, Xi’an (CN)

(73) Assignee: XI’AN LANSHEN NEW MATERIAL TECHNOLOGY CO., LTD., Xi’an (CN)

(21) Appl. No.: 18/218,036

(22) Filed: Jul. 4, 2023

(51) Int. Cl. C01D 15/08; C01B 32/50; C02F 1/44; C02F 1/52

(52) U.S. Cl. CPC C01D 15/08; C01B 32/50; C02F 1/441; C02F 1/5236; C02F 2101/10; C02F 2103/007

(57) ABSTRACT

The disclosure discloses a device and method for recovering lithium from lithium-containing mother liquor in the process of preparing lithium carbonate. The preparation of sodium carbonate solution using the mother liquor produced during lithium carbonate rinsing can recover part of lithium, reduce the water amount required for preparing sodium carbonate and decrease the solvent consumption. The mother liquor generated from lithium precipitation reaction is divided into two parts. One directly flows into the lithium chloride refining unit and mixes with the lithium chloride feed liquor. Carbonate and hydroxide present in this part of lithium-precipitation mother liquor, which can deeply remove the calcium and magnesium ions in the lithium chloride feed liquor, for refining the lithium chloride feed liquor, and removing impurities and recovering lithium from the primary lithium-precipitation mother liquor.

### CROSS-REFERENCE TO RELATED APPLICATIONS

The present application claims the priority and benefit of Chinese Patent Application No. 202210375497.X, filed on Apr. 11, 2022. The disclosure of the above application is incorporated herein by reference in its entirety.

### TECHNOLOGY FIELD

The disclosure applies to the field of extracting lithium from saline lakes, in particular related to a device and method for recovering lithium from lithium-containing mother liquor in the process of preparing lithium carbonate.

### BACKGROUND ART

Lithium is widely used as a battery cathode and ternary material, and is a new strategic energy source in the 21st century. China's lithium extraction industry from saline lakes has developed rapidly in the past decade, with constant breakthroughs in various technologies. Lithium extraction from saline lakes is an important part of “building a world-class saline lake industry base and a national clean energy industry highland”. In the development process of lithium extraction industry from saline lakes, how to efficiently extract lithium from brine with high yield has always been a focus and hotspot of production enterprises for research and development.

At present, the adsorption and membrane methods are two representatives for extracting lithium from saline lakes. Both technologies are designed to preferentially extract lithium from saline lake brine, and then obtain lithium-rich lithium chloride solution (referred to as lithium-rich solution) by refining and concentration technology and react with sodium carbonate to produce lithium carbonate. In the production process of converting the reaction product of lithium-rich solution and sodium carbonate to lithium carbonate, a large amount of mother liquor containing lithium (saline solution containing lithium) will be produced. The lithium in this part of mother liquor accounts for about 20% of the production capacity. At present, production enterprises generally recover lithium by salt field evaporation technology after neutralization or lithium phosphate preparation, which are deficient in low recovery rate, a large number of solid waste, tail salt and carbon dioxide emissions, high recovery cost, etc.

### SUMMARY

This disclosure is intended to provide a device and method for recovering lithium from lithium-containing mother liquor in the process of preparing lithium carbonate to solve the existing problem in recovering alkaline solution containing lithium salt discharged in the process the lithium extraction from saline lake to prepare lithium carbonate.

The disclosure is implemented through the following technical proposal:

A device for recovering lithium from lithium-containing mother liquor in the process of preparing lithium carbonate comprises of: lithium chloride refining unit, lithium chloride filtering unit, lithium precipitation reaction unit, lithium carbonate filtering unit, rinsing unit, sodium carbonate preparation unit, neutralization reaction unit and adsorption/desorption device;

The feed liquor inlet of the lithium chloride refining unit receives lithium chloride feed liquor; the reaction solution outlet of the lithium chloride refining unit is connected to the inlet of the lithium chloride filtering unit; the lithium chloride solution outlet of the lithium chloride filtering unit is connected to the lithium chloride solution inlet of the lithium precipitation reaction unit; the reaction solution outlet of the lithium precipitation reaction unit is connected to the inlet of the lithium carbonate filtering unit. The lithium-precipitation mother liquor outlet of the lithium carbonate filtering unit is divided into two routes: one is connected to the lithium-precipitation mother liquor inlet of the lithium chloride refining unit, and the other is connected to that of the neutralization reaction unit; the lithium-precipitation mother liquor discharged from the neutralization reaction unit is adsorbed and eluted by the adsorption/desorption unit. The eluent is divided into two routes: one goes into the lithium chloride refining unit and the other into the sodium carbonate preparation unit; the sodium carbonate solution outlet of the sodium carbonate preparation unit is connected to the sodium carbonate inlet of the lithium precipitation reaction unit.

The precipitation outlet of the lithium carbonate filtering unit is connected to the lithium carbonate inlet of the rinsing unit, and the liquid outlet of the rinsing unit is connected to the solvent inlet of the sodium carbonate preparation unit.

Preferably, it also comprises of a concentration unit; the eluent is divided into two routes: one enters the concentration unit, and the liquid outlet of the concentration unit is connected to the lithium chloride inlet of the lithium chloride refining unit; the other enters the sodium carbonate preparation unit.

Furthermore, it also comprises of an evaporation unit; the eluate is divided into two routes: one enters the concentration unit, the liquid outlet of the concentration unit is connected to the inlet of the evaporation unit, and the liquid outlet of the evaporation unit is connected to the lithium chloride inlet of the lithium chloride refining unit; the other enters the sodium carbonate preparation unit.

Preferably, it also comprises of a sodium carbonate filtration unit; the sodium carbonate solution outlet of the sodium carbonate preparation unit is connected to the liquid inlet of the sodium carbonate filtering unit, and the liquid outlet of the sodium carbonate filtering unit is connected to the sodium carbonate inlet of the lithium precipitation reaction unit.

Preferably, it also comprises of a gas recovery unit and a compression unit; the gas outlet of the neutralization reaction unit is connected to the gas inlet of the gas recovery unit, and the gas outlet of the gas recovery unit is connected to the inlet of the compression unit.

A method for recovering lithium from lithium-containing mother liquor in the process of preparing lithium carbonate, including:
S1. The lithium chloride feed liquor is refined and filtered to obtain refined lithium chloride solution, which will be subjected to lithium precipitation reaction with sodium carbonate solution. After that, it will be filter to obtain the lithium-precipitation mother liquor (M1) and crude lithium carbonate. The crude lithium carbonate product will be rinsed with water to obtain rinsing mother liquor (M2) and refined lithium carbonate;
S2. M2 is used as the solvent for preparing sodium carbonate solution; the prepared sodium carbonate solution and refined lithium chloride solution are subjected to lithium precipitation reaction;
S3. M1 is divided into two parts, primary lithium-precipitation mother liquor (M1-1) and the secondary lithium-precipitation mother liquor (M1-2). M1-1 will flow back to S1 for refining together with the lithium chloride feed liquor; M1-2 is to be neutralized by acid solution, and then adsorbed and eluted to obtain pure lithium chloride solution (M1-3);
S4. M1-3 is divided into two parts: one is used as the solvent for preparing sodium carbonate solution, and the other will flow back to S1 for refining together with the lithium chloride feed liquor.

Preferably, in S3, the gas (G1) generated by neutralization reaction will be rinsed, condensed, dried and compressed to obtain industrial grade carbon dioxide (G2).

Preferably, in S3, the discharged solution after the neutralized M1-2 is adsorbed using a adsorption/desorption unit will be returned back to the saline lake.

Preferably, in S4, the pure lithium chloride solution M1-3 is divided into two parts: one is used as the solvent for preparing sodium carbonate solution, and the other will flow back to S1 for refining together with the lithium chloride feed liquor.

Furthermore, the water generated by concentration returns to S3 as a desorption agent for elution treatment after M1-2 adsorption.

Compared with the existing technology, this disclosure has the following advantageous effects:

First of all, the method disclosed in this disclosure simply classify the lithium-containing mother liquor produced during lithium carbonate preparation. Solutions produced in different process steps preferably adopt corresponding treatments. On the one hand, the preparation of sodium carbonate solution using the mother liquor produced during lithium carbonate rinsing can recover part of lithium, reduce the water amount required for preparing sodium carbonate and decrease the solvent consumption. On the other hand, the lithium-precipitation mother liquor generated from lithium precipitation is divided into two parts. One directly flows into the lithium chloride refining unit and mixes with the lithium chloride feed liquor. Carbonate and hydroxide present in this part of the lithium-precipitation mother liquor, which can deeply remove the calcium and magnesium ions in the lithium chloride feed liquor, for refining the lithium chloride feed liquor, and removing impurities and recycling lithium from the primary lithium-precipitation mother liquor. The other is mainly used for two purposes: some can be used as the solvent for preparing sodium carbonate solution after removing impurities, and the other will flow into the lithium chloride refining unit to recover the lithium contained and further reduce solvent consumption. Through the implementation of the disclosure, the lithium yield can be increased from about 80% to above 98% in the traditional process of producing lithium carbonate from lithium chloride feed liquor. This disclosure not only improves the recovery rate of lithium, but also reduces consumption and waste discharge. Therefore, it can systematically solve the problems of low recovery rate of lithium from lithium-containing mother liquor, great amount of waste discharge and high recovery cost in the production of lithium carbonate.

Furthermore, the gas generated by neutralization reaction is rinsed, condensed, dried and compressed to obtain industrial grade carbon dioxide to avoid carbon dioxide emission and improve economic benefits.

Furthermore, some pure lithium chloride solution is concentrated and returned to the lithium chloride refining process to recover part of the lithium.

Furthermore, the water generated by concentration is used as a desorption agent to return to the adsorption and desorption process, thus reducing water consumption.

When using the device presented in the disclosure, on the one hand, the rinsing mother liquor produced by rinsing lithium carbonate is used to prepare sodium carbonate solution, so as to recover this part of lithium, reduce the water amount required for preparing sodium carbonate and decrease the solvent consumption; On the other hand, the mother liquor generated from lithium precipitation reaction is divided into two parts. One directly flows into the lithium chloride refining unit and mixes with the lithium chloride feed liquor. Carbonate and hydroxide present in this part of the lithium-precipitation mother liquor, which can deeply remove the calcium and magnesium ions in the lithium chloride feed liquor, for refining the lithium chloride feed liquor, and removing impurities and recovering lithium from the primary lithium precipitation mother liquor. The other is mainly used for two purposes: some can be used as the solvent for preparing sodium carbonate solution after removing impurities, and the other will flow into the lithium chloride refining unit to recover the lithium contained and further reduce solvent consumption. Through the implementation of the disclosure, the lithium yield can be increased from about 80% to above 98% in the traditional process of producing lithium carbonate from lithium chloride feed liquor. The lithium-containing solution recovered in the disclosure is organically combined with the sodium carbonate preparation process, rinsing process and impurity removal and refining process in the main lithium carbonate production unit, making full use of the original device, reducing device investment and improving device utilization while ensuring the recovery effect. Compared with the existing method for recovering lithium from lithium-containing mother liquor, the disclosure has such obvious advantages as high recovery rate of lithium, short recovery cycle, high compatibility with the main device for lithium carbonate production, low consumption of other raw materials in the recovery process, low cost, and no three wastes generated in the recovery process. The disclosure provides a set of solutions for manufactures producing lithium carbonate by extracting lithium from saline lakes or other lithium salt manufacturers, which is of significant economic benefits. Furthermore, if it is extended to other lithium-containing mother liquor or waste liquid generated throughout the process line of lithium extraction from saline lake, it can be categorized to corresponding processes for lithium recovery based on the solution component classification at each stage mentioned above.

### BRIEF DESCRIPTION OF THE DRAWINGS

FIG. 1: recovery route map of lithium-containing mother liquor; typical process route for preparing lithium carbonate from lithium chloride is shown in the dotted frame.

FIG. 2: Schematic diagram of neutralization reactor.

FIG. 3 Structural diagram of the device in the disclosure.

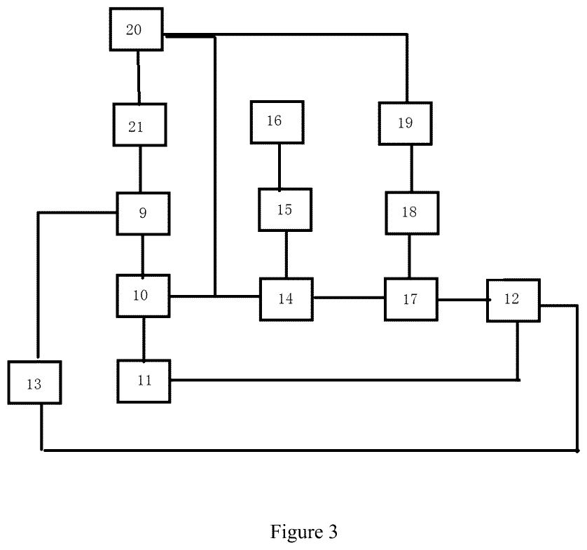

The figure shows the following units: lithium-precipitation mother liquor inlet 1, gas outlet 2, central cylinder 3, central cylinder support 4, agitator 5, hydrochloric acid feeding port 6, lithium chloride refining unit 20, lithium chloride filtering unit 21, lithium precipitation reaction unit 9, lithium carbonate filtering unit 10, rinsing unit 11, sodium carbonate preparation unit 12, sodium carbonate filtering unit 13, neutralization reactor 14, gas recovery unit 15, compression unit 16, adsorption/desorption unit 17, concentration unit 18, and evaporation unit 19.

### DETAILED DESCRIPTION

In order to further understand this disclosure, the following descriptions are provided in conjunction with examples. These descriptions are only intended to further explain the features and advantages of the disclosure but not intended to limit the claims of the disclosure.

The disclosure discloses a device for recovering lithium from lithium-containing mother liquor in the process of extracting lithium from saline lake to prepare lithium carbonate, including: lithium chloride refining device 20, lithium chloride filtering device 21, lithium precipitation reaction unit 9, lithium carbonate filtering unit 10, rinsing unit 11, sodium carbonate preparation unit 12, sodium carbonate filtering device 13, neutralization reactor 14, gas recovery unit 15, compression unit 16, adsorption/desorption unit 17, concentration unit 18, and evaporation unit 19. The concentration unit 18 specifically employs a reverse osmosis concentration unit, and the evaporation unit 19 specifically adopts a forced evaporator.

Lithium chloride refining unit 20 receives lithium chloride feed liquor, of which lithium chloride feed liquor is the intermediate product liquid produced by saline lake lithium extraction adsorption method or nanofiltration membrane method.

The reaction solution outlet of the unit 20 is connected to the inlet of the unit 21; the lithium chloride solution outlet of the unit 21 is connected to the lithium chloride solution inlet of the unit 9; the reaction solution outlet of the unit 9 is connected to the inlet of the unit 10. The lithium-precipitation mother liquor outlet of the unit 10 is divided into two routes: one is connected to the lithium-precipitation mother liquor inlet of the unit 20, and the other is connected to that of the unit 14.

The gas outlet of the unit 14 is connected to the gas inlet of the unit 15, and the gas outlet of the unit 15 is connected to the inlet of the unit 16.

The lithium-precipitation mother liquor discharged from discharge port 7 of the unit 14 is adsorbed and eluted by the unit 17. The elution liquid is divided into two routes, one entering the unit 18 and the other entering the unit 12. The outlet of the unit 18 is connected to the inlet of the unit 19, and the outlet of the unit 19 is connected to the lithium chloride solution inlet of the unit 20.

The precipitation outlet of the unit 10 is connected to the lithium carbonate inlet of the unit 11, and the liquid outlet of the unit 11 is connected to the solvent inlet of the unit 12. The sodium carbonate solution outlet of the unit 12 is connected to the liquid inlet of the unit 13, and the liquid outlet of the unit 13 is connected to the sodium carbonate inlet of the unit 9.

A method for recovering lithium from lithium-containing mother liquor in the process of extracting lithium from saline lake to prepare lithium carbonate includes the following steps:
S1. First, the lithium-containing mother liquor produced in the process of lithium carbonate is classified, including the lithium-precipitation mother liquor M1 obtained after lithium chloride and sodium carbonate are converted into lithium carbonate through lithium precipitation reaction and filtered, and the rinsing mother liquor M2 produced by washing lithium carbonate in stages with pure water after the reaction and separation, as well as the solution in magnesium removal from lithium chloride, filtration, rinsing and other processes. The classified lithium precipitation mother liquor M1 and rinsing mother liquor M2 are stored separately.
S2. The rinsing mother liquor M2 is pumped to the sodium carbonate preparation unit 12 as the solvent for preparing solid sodium carbonate. In the preparation process, a certain amount of sodium hydroxide is added to adjust the pH of sodium carbonate solution, stirred, fully dissolved, and then transferred to the precision filter to filter and remove suspended compounds and insoluble substances containing calcium and magnesium in the solution to obtain pure sodium carbonate solution N1, which is transferred to the reactor for lithium precipitation reaction with lithium chloride to produce lithium carbonate, so as to realize the circulation and recovery of lithium in M2 solution in the system.
S3. The lithium precipitation mother liquor M1 is divided into the primary lithium precipitation mother liquor M1-1 and the secondary lithium precipitation mother liquor M1-2 as required. M1-1 is pumped to the lithium chloride refining unit 20, where the calcium and magnesium ions in the lithium chloride feed liquor are deeply removed to produce basic magnesium carbonate and calcium carbonate precipitation. The filtered solution flows into the reaction tank for lithium precipitation reaction, so as to remove impurities and recover lithium in M1-1.
S4. Furthermore, the said M1-2 solution is transferred to a neutralization tank, and hydrochloric acid solution is introduced to adjust the pH value to slightly acidic. The gas G1 generated by neutralization is washed, condensed, dried, and compressed in the gas recovery unit 15 to obtain industrial grade carbon dioxide G2.
S5. The neutralized M1-2 is transferred to the adsorption/desorption device 17 to extract lithium by adsorption method, and then the pure lithium chloride solution M1-3 is obtained after washing and replacement with pure water and desorption with the desorption agent. The M1-2 after absorbing lithium is discharged back to the saline lake system.

Part of the pure lithium chloride solution M1-3 is transferred to the reverse osmosis concentration unit 18 for concentration to obtain 3%˜4.5% of the primary concentrated lithium chloride solution M1-4, and the water produced by concentration, as the desorption agent, is discharged back to the adsorption/desorption unit 17 for circulation. The primary concentrated lithium chloride solution M1-4 is transferred to the forced evaporator for further concentration to obtain 12%-15% of the secondary concentrated lithium chloride solution M1-5, and the evaporated condensate water, as the desorption agent, is discharged back to the adsorption/desorption unit 17 for circulation. There is also a portion of pure lithium chloride solution M1-3 used as the solvent for preparing sodium carbonate solution.

The M1-5 solution is transferred to the lithium-rich solution and mixed with the fresh solution of the original system to obtain battery grade lithium carbonate product through reaction, separation, rinsing and drying. As mentioned above, the recovery of lithium from the M1-2 solution is completed.

### Specifically, in S1:

(1) The components of the M1 solution include Li+: 1.3˜2.2 g/L, Na+: 45˜75 g/L, K+: 1˜3 g/L, Mg2+: 0.001˜0.05 g/L, Ca2+: 0.005˜0.05 g/L, Cl−: 76.6˜180 g/L, CO32−: 10˜20 g/L, OH−: 3-7 g/L, and SO42−: 0.01˜0.5 g/L. The components of the M2 solution: Li+: 1.3˜2.2 g/L, Na+: 1.0˜2.0 g/L, K+: 0.02˜0.07 g/L, Mg2+: 0.001˜0.01 g/L, Ca2+: 0.005˜0.01 g/L, Cl−: 2˜5 g/L, CO32−: 0.2˜0.4 g/L, and OH−: 0.05˜0.3 g/L.

(2) The lithium in the said M1 solution accounts for 75%-85% of the total lithium recovered from the lithium-containing mother liquor, and 14%-17% of the capacity of the lithium carbonate production line; lithium in M2 solution accounts for 15%-25% of the total lithium recovered from the lithium-containing mother liquor, and accounts for 3%-6% of the capacity of lithium carbonate production line.

(3) The solid content (suspended lithium carbonate) of lithium precipitation mother liquor M1 and rinsing mother liquor M2 is about 0.5 g/L, and the temperature is 20° C.˜80° C.

(4) The transportation pipeline and storage tank material for lithium precipitation mother liquor M1 and rinsing mother liquor M2 are made of steel lined PE or 2205 or titanium alloy. The transportation is carried out by artesian flow or pump, and the residence time of storage tank is 0.5-2 hours.

### Specifically, in S2:

(1) Rinsing mother liquor M2 is used as solvent to prepare sodium carbonate solution with a concentration of 200 g/L-300 g/L. Pure water or steam condensate in the lithium carbonate production line is used for the part with insufficient solvent in the preparation process. The volume ratio of rinsing mother liquor M2 to pure water is 1:0.5-1:3, and the preparation temperature is 50-60° C.

(2) The sodium carbonate solution prepared is added with sodium hydroxide to adjust the pH value of the solution to 10.5-11.5, and stirred for more than 30 minutes to deeply remove magnesium ions and other metal ions.

(3) In the prepared sodium carbonate solution N1, the lithium concentration is 0.25-0.75 g/L.

(4) The prepared sodium carbonate solution N1 is filtered using a precision filter, with a PE microporous membrane core and a filtration accuracy of 5 μm. The filtration pressure is 0.1-0.3 Mpa, and the filtration pressure difference is controlled to be less than 0.2 Mpa.

### Specifically, in S3:

(1) The carbonate and hydroxide ion in M1-1 are added to the lithium chloride feed liquor to preliminarily remove calcium and magnesium ions in the lithium chloride feed liquor, and react to produce basic magnesium carbonate and calcium carbonate precipitation, so as to achieve refining. It is necessary to control the amount of carbonate to not cause lithium carbonate precipitation.

(2) Calculate and determine the addition amount of M1-1 when the lithium ion concentration of the solution after mixing the primary precipitation lithium mother liquor M1-1 and lithium chloride solution is greater than or equal to 20 g/L.

(3) After mixing the M1-1 with the lithium chloride feed liquor, the insufficient part of calcium and magnesium ions removed shall be supplemented with a mixed solution of 30% sodium hydroxide and 10% sodium carbonate, preferably with a pH value greater than 10.5 as the determination of the reaction end point.

(4) The temperature in the said reaction process is controlled to 60° C.-65° C.

### Specifically, in S4:

(1) The M1-2 undergoes neutralization reaction and flows into the adsorption device to extract lithium.

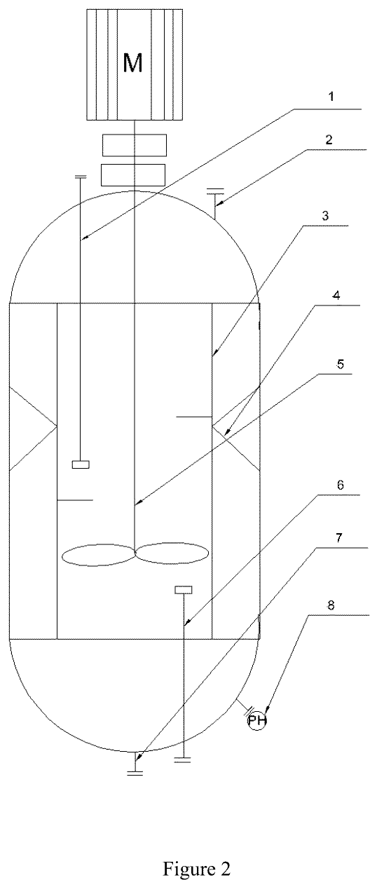

(2) Specifically, the structure of neutralization reactor 14 in the disclosure is shown in FIG. 2, including the reactor body, which is provided with a central cylinder 3. The top of the reactor body is equipped with a lithium precipitation mother liquor inlet 1 and a gas outlet 2, the inlet 1 is connected to the central cylinder 3. Between the reactor body and the central cylinder 3 is provided a central cylinder support 4, the central cylinder 3 is provided with a stirrer 5, and the bottom of the reactor body is provided with a hydrochloric acid feeding port 6. The feeding port 6 is connected to the central cylinder 3, and the bottom of the reactor body is provided with a discharge port 7 and a pH detector 8. Compared to conventional neutralization reactor 14, the neutralization reactor 14 in this disclosure is a continuous reactor that achieves efficient and continuous treatment through stirring, reactor structure, and feed control; the continuous reaction can reduce device usage and manpower investment, making device more efficient; neutralization reactor 14 is preferably an enamel reactor, which is a continuous reactor. The reaction stirring is carried out in the form of a three-blade paddle upward propulsion agitating. The neutralization reaction time is controlled by controlling the stirring speed, and the preferred contact time for the reaction is 10 to 15 minutes.

(3) The addition of acid to neutralization reactor 14 during the reaction is by the bottom feeding, and the acid outlet adopts a distributor and is installed below the stirring blades.

(4) The addition of M1-2 to the neutralization reactor 14 is by the middle feeding, and the solution outlet adopts a distributor and is installed above the stirring blades.

(5) A peripheral central cylinder is installed inside the neutralization reactor 14, and a baffle turbulence device is installed in the direction of mixing propulsion.

(6) The feeding ratio of the M1-2 and hydrochloric acid is controlled through pH monitoring interlocking, and the pH value of the neutralization reaction is between 6.0 and 6.6.

(7) The by-product carbon dioxide recovered from the reaction can be used as raw material for preparing high-purity lithium carbonate or for sale.

### Specifically, in S5:

(1) The material used for adsorbing lithium in the M1-2 is aluminum-based lithium adsorbent. The amount of lithium adsorbent used is calculated based on the exchange capacity per unit time and the lithium amount recovered from the M1-2 per unit time.

(2) The adsorption device adopts continuous ion exchange device, which is composed of four parts, 10 sets of triple adsorption columns, 60-channel valve cores, turntables and controllers. Lithium adsorbent is filled into a triple resin column and divided into 30 independent units, numbered 1#, 2#, 3# . . . 29#, 30#, where the corresponding column positions 1# to 10# are adsorption areas, the corresponding column positions 11# to 18# are rinsing and replacement areas, and the corresponding column positions 19# to 30# are desorption areas. Each column position is divided into upper and lower access ports and corresponds to 60-channel valve cores. The resin column is positioned on the turntable.

(3) During operation, the controller controls the rotation of the turntable to achieve sequential switching of any resin column unit at different column positions. The process control conditions are mainly composed of the rotation time and frequency of the turntable, as well as the inlet and outlet flow rates of each column position. As described above, the continuous operation of lithium adsorbents in the 30 independent units is so achieved, that is, during the continuous operation, the 1# to 10# column positions corresponding to the resin column at the same time period adsorb lithium in the M1-2. The corresponding positions 11# to 18# are being washed and replaced with pure water, while the corresponding positions 19# to 30# are being used to desorb the lithium ions on the lithium adsorbent.

(4) The produced solution from the rinsing and replacement area is returned to the adsorption area or used as raw water for the rinsing area based on conductivity judgment.

(5) The lithium yield of step S5 is 90%-95%. After adsorption, the main components of the M1-2 lithium are Li+: 0.05˜0.2 g/L, Na+: 40˜60 g/L, K+: 1˜2 g/L, Mg2+: 0.001˜0.05 g/L, and Ca2+: 0.005˜0.05 g/L. The components in the solution all come from the saline lake, so they can be directly discharged back to the saline lake without affecting the composition of the saline lake brine.

(6) The main components of pure lithium chloride solution M1-3 produced in S5 step are Li+: 0.4˜0.7 g/L, Na+: 0.1˜0.3 g/L, K+: 0.005˜0.01 g/L, Mg2+: 0.001˜0.005 g/L, and Ca2+: 0.001˜0.005 g/L.

(7) A small part of the M1-3 can be used as the rinsing water for crude lithium carbonate and the solvent for preparing sodium carbonate solution, so as to reduce the loss of lithium in the production of lithium carbonate. Its amount is determined according to the demand of the subsequent process.

(8) Furthermore, most of the pure lithium chloride solution M1-3 after filtration flows to the reverse osmosis concentration device 18 for concentration and the water in the solution is recovered. Where, secondary filtration is preferred for filtration, with filtration accuracy of 10 μm and 3 μm respectively. The reverse osmosis membrane is preferably a seawater type reverse osmosis membrane with a concentration factor of 10-15. The components of the M1-4 obtained from the concentrated water of the M1-3 include Li+: 6˜7 g/L, Na+: 1.5˜4.5 g/L, K+: 0.05˜0.1 g/L, Mg2+: 0.01˜0.005 g/L, and Ca2+: 0.001˜0.005 g/L.

(9) The components of the M1-5 obtained by concentration of M1-4 include Li+: 22˜30 g/L, Na+: 5.5˜22.5 g/L, K+: 0.2˜0.5 g/L, Mg2+: 0.05˜0.02 g/L, and Ca2+: 0.005˜0.02 g/L.

### EXAMPLE

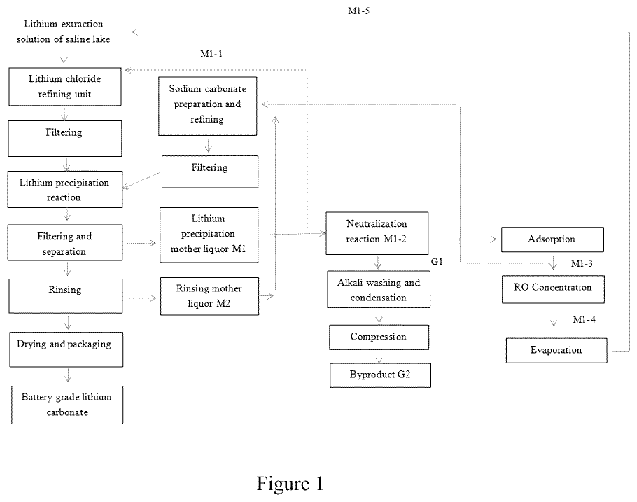

Step S1: In the process of preparing lithium carbonate in FIG. 1, rinsing mother liquor M2 is obtained by pure water rinsing and filtering, and the flow rate is 5 times that of lithium carbonate product. The solution components contain 1.6 g/L lithium ion, 1.8 g/L sodium ion, 0.05 g/L potassium ion, 0.005 g/L magnesium ion, 0.01 g/L calcium ion, *g/L chloride ion, 12.2 g/L carbonate, and 0.2 g/L hydroxide ion. The temperature is 75° C. It is calculated that the lithium in this solution accounts for 4.23% of the production capacity of lithium carbonate.

The above rinsing mother liquor M2 is mixed with pure water or pure lithium chloride solution M1-3 in a ratio of 1:0.6 as the solvent for preparing 260 g/L sodium carbonate. During the preparation, 30% sodium hydroxide solution is added to adjust the pH to 10.8, and the temperature of sodium carbonate solution is controlled at 55° C.-60° C., and the mixture is stirred for 30 minutes to ensure that sodium carbonate is fully dissolved and impurities are fully reacted and precipitated.

The prepared sodium carbonate solution is transferred to a precision filter and filtered to obtain a refined sodium carbonate solution N1, with a concentration of 260 g/L sodium carbonate and a lithium content of 1 g/L. The said N1 reacts with 120 g/L lithium chloride solution to precipitate lithium carbonate.

It can be seen that the rinsing mother liquor M2 in step S1 realizes a closed cycle in the system for preparing lithium carbonate, and the only loss comes from the cleaning and slag removal process of the precision filter, which is basically ignored, so as to realize the recovery of lithium from rinsing mother liquor M2. At the same time, the rinsing mother liquor M2 with a temperature of 75° C. is used as the solvent for preparing sodium carbonate, replacing some pure water and the required heat for preparation, reducing the water and heat consumption in the sodium carbonate preparation.

Step S2: As shown in FIG. 1, in the process of producing lithium carbonate, the lithium carbonate prepared is filtered to obtain lithium precipitation mother liquor M1. The flow is 1.8 times of lithium chloride raw material. The solution components contain 1.5 g/L lithium ion, 60 g/L sodium ion, 2.3 g/L potassium ion, 0.005 g/L magnesium ion, 0.01 g/L calcium ion, *g/L chloride ion, 15 g/L carbonate, and 4.5 g/L hydroxide ion. The temperature is 77° C. It is calculated that the lithium in this solution accounts for 13.5% of the production capacity of lithium carbonate.

For the said lithium precipitation mother liquor M1, 10% is transferred to the lithium chloride refining area in FIG. 1 and counted as M1-1. It is mixed with lithium chloride feed liquor for reaction and impurity removal. The lithium chloride feed liquor is the intermediate product liquid produced by the saline lake lithium extraction adsorption method or nanofiltration membrane method. Its main components include 24 g/L lithium content, 3.2 g/L calcium and magnesium content, and 2.7 g/L potassium content.

Mix the lithium chloride feed solution and the M1-1. Adjust and maintain the temperature at 60° C. Detect the pH value of the mixed solution. If the pH value is less than 10.5, add 30% sodium hydroxide, adjust the pH value to 10.7, stir for 30 minutes, filter, and transfer to the lithium precipitation reaction area.

It can be seen that the M1-1 in step S2 also realizes a closed cycle in the system for preparing lithium carbonate. The only loss comes from the entrainment of filtered basic magnesium carbonate filter residue that can be recovered through rinsing, which can be basically ignored, so as to realize the recovery of lithium from the M1-1. At the same time, the temperature of M1-1 is 75° C., and it contains 15 g/L carbonate and 4.5 g/L hydroxide ion, which can react with calcium and magnesium ions in the lithium chloride feed solution to precipitate and remove impurities and heat, thus replacing some raw materials and heat required for refining.

90% of the lithium precipitation mother liquor is transferred to the continuous neutralization reactor 14 to obtain M1-2, as shown in FIG. 2. Hydrochloric acid and M1-2 are simultaneously added for the neutralization reaction, and the feeding amount of hydrochloric acid and M1-2 is controlled through pH signal interlocking. The pH value is controlled at 6.5.

The carbon dioxide gas generated by neutralization is neutralized by introducing 5% soda through an induced draft fan, absorbing the acidic gas carried by the gas, and then condensing at −30° C. to −40° C. before being connected to a compressor to produce industrial grade carbon dioxide.

It can be seen that the neutralization reaction is carried out by a continuous method, which is more efficient and energy-saving; in addition, the by-product carbon dioxide is used as the raw material for the factory to produce high-purity lithium carbonate.

The neutralized M1-2 is transferred to the continuous ion adsorption lithium extraction unit to recover lithium. After adsorption, rinsing and replacement and desorption, the pure lithium chloride solution M1-3 is obtained. Its components include 0.55 g/L lithium ion, 0.13 g/L sodium ion, 0.01 g/L potassium ion, 0.005 g/L magnesium ion, 0.005 g/L calcium ion, and *g/L chloride ion. The temperature is 25° C. The total lithium amount in M1-3 accounts for 93% of M1-2.

The feeding temperature of the M1-2 is 35° C., and the continuous ion adsorption lithium extraction device is divided into 30 units and filled with aluminum-based lithium adsorbents. Among them, 12 units serve as the adsorption zone, with a combination of 3 in parallel and 4 in series. The M1-2 flows in and out continuously from the adsorption zone. And 10 unit serve as the desorption zone, where pure water continuously enters and exits. A portion of the generated desorption solution is treated as a pure lithium chloride solution M1-3 in the reverse osmosis concentration process or washed as shown in FIG. 1 to clean the salt in lithium carbonate, and the other is circulated in the continuous ion adsorption lithium extraction device as raw materials for the rinsing and replacement zone. And 8 units serve as the rinsing and replacement zone. Some pure lithium chloride solution continuously flows in and out from the rinsing and replacement zone, and the replacement solution is discharged back and mixed with the M1-2.

It can be seen that the recovery amount of lithium in the adsorption zone accounts for over 70% of the lithium content in all mother liquor. The extraction of lithium in the solution is achieved through adsorption method. The continuous ion exchange adsorption lithium extraction device adopts a fully automatic control scheme, which has high device and operational efficiency and significant economic benefits. Meanwhile, the process method for continuously extracting lithium from M1-2 solution developed by this disclosure is also of great significance for reference for lithium extraction from saline lake brine.

The pure lithium chloride solution M1-3 produced by the continuous ion adsorption lithium extraction unit, after reverse osmosis concentration and MVR forced evaporation, can produce a high concentration of lithium chloride solution, whose components include 25 g/L lithium ion, 5.98 g/L sodium ion, 0.47 g/L potassium ion, 0.23 g/L magnesium ion, 0.2 g/L calcium ion, and *g/L chloride ion, which is discharged to the typical process route of preparation of lithium carbonate from lithium chloride in FIG. 1 to prepare lithium carbonate, realize a closed loop cycle of lithium, while the clear water generated by concentrated reverse osmosis and forced evaporation and returning to the continuous ion adsorption lithium extraction device is used as desorption agent for cyclic utilization.

To sum up, this disclosure proposes a complete set of solutions for M1 and M2 lithium-containing solutions or similar component solutions produced by the preparation of lithium carbonate. This method has such salient advantages as high lithium recovery rate, short recovery cycle, high compatibility with the main device for lithium carbonate production, low consumption of other raw materials in the recovery process, no three wastes produced in the recovery process, which is of significant economic benefits.

What is claimed is:

1. A method for recovering lithium from lithium-containing mother liquor in the process of preparing lithium carbonate, comprising:
S1. The lithium chloride feed liquor is refined and filtered to obtain refined lithium chloride solution, which will be subjected to lithium precipitation reaction with sodium carbonate solution. After that, it will be filtered to obtain the lithium-precipitation mother liquor (M1) and crude lithium carbonate. The crude lithium carbonate product will be rinsed with water to obtain rinsing mother liquor (M2) and refined lithium carbonate;
S2. M2 is used as the solvent for preparing sodium carbonate solution; the prepared sodium carbonate solution and refined lithium chloride solution are subjected to lithium precipitation reaction;
S3. M1 is divided into two parts, primary lithium-precipitation mother liquor (M1-1) and the secondary lithium-precipitation mother liquor (M1-2). M1-1 will flow back to S1 for refining together with the lithium chloride feed liquor; M1-2 is to be neutralized by acid solution, and then adsorbed and eluted to obtain pure lithium chloride solution (M1-3); and
S4. M1-3 is divided into two parts: one is used as the solvent for preparing sodium carbonate solution, and the other will flow back to S1 for refining together with the lithium chloride feed liquor.

2. The method for recovering lithium from lithium-containing mother liquor in the process of preparing lithium carbonate of claim 1, wherein in S3, the gas (G1) generated by neutralization reaction will be rinsed, condensed, dried and compressed to obtain industrial grade carbon dioxide (G2).

3. The method for recovering lithium from lithium-containing mother liquor in the process of preparing lithium carbonate of claim 1, wherein in S3, the solution discharged after the neutralized M1-2 is adsorbed will be returned back to the saline lake.

4. The method for recovering lithium from lithium-containing mother liquor in the process of preparing lithium carbonate of claim 1, wherein in S4, M1-3 is divided into two parts: one is used as the solvent for preparing sodium carbonate solution, and the other will be concentrated and flow back to S1 for refining together with the lithium chloride feed liquor.

5. The method for recovering lithium from lithium-containing mother liquor in the process of preparing lithium carbonate of claim 1, wherein the water generated by concentration returns to S3 as a desorption agent for elution treatment after M1-2 adsorption.

6. A device for recovering lithium from lithium-containing mother liquor in the process of preparing lithium carbonate, comprising:
a lithium chloride refining unit (20), a lithium chloride filtering unit (21), a lithium precipitation reaction unit (9), a lithium carbonate filtering unit (10), a rinsing unit (11), a sodium carbonate preparation unit (12), a neutralization reaction unit and adsorption/desorption unit (17);
wherein the feed liquor inlet of unit (20) receives lithium chloride feed liquor; the reaction solution outlet of the unit (20) is connected to the inlet of the unit (21); the lithium chloride solution outlet of the unit (21) is connected to the lithium chloride solution inlet of the unit (9); the reaction solution outlet of the unit (9) is connected to the inlet of the unit (10). The lithium-precipitation mother liquor outlet of the unit (10) is divided into two routes: one is connected to the lithium-precipitation mother liquor inlet of the unit (20), and the other is connected to that of the neutralization reaction unit; the lithium-precipitation mother liquor discharged from the neutralization reaction unit is adsorbed and eluted by the unit (17). The eluent is divided into two routes: one goes into the unit (20) and the other into the unit (12); the sodium carbonate solution outlet of the unit (12) is connected to the sodium carbonate inlet of the unit (9);
the precipitation outlet of the unit (10) is connected to the lithium carbonate inlet of the unit (11), and the liquid outlet of the unit (11) is connected to the solvent inlet of the unit (12).

7. The device for recovering lithium from lithium-containing mother liquor in the process of preparing lithium carbonate of claim 6, further comprises: a concentration unit (18); wherein the eluent is divided into two routes: one enters the unit (18), and the liquid outlet of the unit (18) is connected to the lithium chloride inlet of the unit (20); the other enters the unit (12).

8. The device for recovering lithium from lithium-containing mother liquor in the process of preparing lithium carbonate of claim 7, further comprises an evaporation unit (19); wherein the eluate is divided into two routes: one enters the unit (18), the liquid outlet of the unit (18) is connected to the inlet of the unit (19), and the liquid outlet of the unit (19) is connected to the lithium chloride inlet of the unit (20); the other enters the unit (12).

9. The device for recovering lithium from lithium-containing mother liquor in the process of preparing lithium carbonate of claim 6, further comprises a sodium carbonate filtering unit (13); wherein the sodium carbonate solution outlet of the unit (12) is connected to the liquid inlet of the unit (13), and the liquid outlet of the unit (13) is connected to the sodium carbonate inlet of the unit (9).

10. The device for recovering lithium from lithium-containing mother liquor in the process of preparing lithium carbonate of claim 6, further comprises a gas recovery unit (15) and a compression unit (16); wherein the gas outlet of the neutralization reaction unit is connected to the gas inlet of the unit (15), and the gas outlet of the unit (15) is connected to the inlet of the unit (16).
